(19) United States
(12) Patent Application Publication
(10) Pub. No.: US 2003/0059581 A1
(43) Pub. Date: Mar. 27, 2003

(54) Flexible radiative heat shield with corrugated substrate

(76) Inventor: Timothy S. Whalen, Howell, MI (US)

Correspondence Address: Synnestvedt & Lechner LLP, Suite 2600, 1101 Market Street, Philadelphia, PA, 19107-2950, US

(21) Appl. No.: 10/255,259

(22) Filed: Sep. 26, 2002

Related U.S. Application Data
(60) Provisional application No. 60/325,095, filed on Sep. 26, 2001.

(51) Int. Cl. B32B 3/28

(52) U.S. Cl. 428/182

(57) ABSTRACT

A heat shield is disclosed having a flexible substrate attached to a corrugated insulating layer. An outwardly facing metalized or metal foil reflecting layer is positioned on the flexible substrate, and air pockets are formed between the corrugation of the insulating layer and the substrate. Resilient elongated filamentary members are distributed throughout the insulating layer and are biased into a waveform shape matched to the corrugations to support the insulating layer and prevent collapse of the air pockets. A reinforcing layer is positioned on the corrugated insulating layer opposite the flexible substrate forming a second layer of air pockets. The reinforcing layer is formed of a scrim of woven or non-woven insulating material.

### RELATED APPLICATION

This application is based on and claims the benefit of U.S. Provisional Application No. 60/325,095, filed Sep. 26, 2001.

### FIELD OF THE INVENTION

The invention concerns a flexible heat shield for reducing radiative and conductive heat transfer.

### BACKGROUND OF THE INVENTION

For reasons of safety and comfort, flexible heat shields are used extensively in automotive, marine and aerospace applications, as well as in home and building construction and in appliances and machinery, to reduce radiative and conductive heat transfer between hot components and cooler components surrounding them. It is often desirable, for example, to insulate the passenger compartment of an automobile from components such as the engine, transmission, and the exhaust system, all of which generate considerable heat, which, if allowed to pass substantially unimpeded into the passenger compartment, can create an unbearable environment for the passengers.

Furthermore, certain engine components, such as the exhaust manifold and the catalytic converter achieve temperatures such that their outer surface, if not thermally shielded, will ignite material, such as oil, gasoline, dried leaves or paper with which they come into contact.

Radiative heat shields are also used extensively in the construction trades to-insulate air conditioning ducting, as well as air conditioning units in HVAC systems. Home appliances such as refrigerators, ovens and dishwashers also benefit from reduced energy usage and increased efficiency when radiative heat shields are employed to reduce unwanted heat transfer. Furthermore, volatile liquids such as gasoline are stored with greater safety when the temperatures at which such liquids are kept are controlled by insulating the container from radiative and conductive heat transfer.

To be effective, heat shields used in these applications should substantially block both radiative and conductive heat transfer between hot and cold components. Furthermore, to be competitive in the marketplace the heat shields should be inexpensive, durable and easily installed. The heat shields should also be relatively flexible and conformable to the complex curved shapes characteristic of automobile components, such as the firewall of an engine compartment, the transmission tunnel in the floor, the cannister of a catalytic converter and the chassis adjacent to the exhaust system. There is clearly a need for a heat shield which combines all of these characteristics.

### SUMMARY AND OBJECTS OF THE INVENTION

The invention concerns a flexible, heat shield for reducing radiative and conductive heat transfer between components at different temperatures. The heat shield according to the invention comprises a flexible substrate having an outwardly facing reflective surface and a flexible insulating layer attached to the substrate on the side opposite to the reflective surface. The insulating layer has corrugations comprising a plurality of crests and troughs. The crests engage the substrate to effect attachment between the insulating layer and the substrate, while the corrugations define a plurality of air pockets positioned between the insulating layer and the substrate. The heat shield is adapted to be mounted on the cooler component, flexibly conforming to its shape, with the reflective surface facing the heat source to effectively block the transfer of radiative heat energy. The combination of air pockets and the insulating layer substantially prevent conductive heat transfer from the reflecting surface. Conductive heat transfer is further inhibited by attaching the substrate to the insulating layer only along the crests, thereby minimizing the physical contact area between the relatively hotter substrate and the cooler insulating layer.

The heat shield may also have a reinforcing layer, attached to the insulating layer opposite the substrate. The reinforcing layer is preferably a scrim comprising woven or non-woven insulating material and engages the troughs for attachment. When a reinforcing layer is present, the corrugations define a second plurality of air pockets, this time between the insulating layer and the reinforcing layer.

If increased strength afforded by the reinforcing layer is not needed, the heat shield may instead have an adhesive layer engaging the troughs for attaching the heat shield to a surface.

Preferably, the substrate comprises a non-conducting layer, such as Mylar with a metalized reflecting surface formed by vacuum depositing a thin aluminum layer. The substrate may also comprise a layer of metal foil.

The insulating layer may comprise glass fiber paper, ceramic paper, polyester or cotton.

Depending upon the material comprising the insulating layer, a plurality of resilient, elongated filamentary members may be distributed throughout it and oriented transversely to the corrugations. The filamentary members are resiliently biasable into a waveform shape matched to the corrugations and resiliently maintain the shape of the crests and troughs, thereby preventing collapse of the air pockets. The biasable filamentary members preferably comprise thermoplastic monofilaments which are readily heat settable into the desired shape.

It is an object of the invention to provide a heat shield for inhibiting conductive and radiative heat transfer.

It is another object of the invention to provide a heat shield which may be deployed over an extended surface.

It is still another object of the invention to provide a heat shield which is flexibly conformable to curved shapes.

It is again another object of the invention to provide a heat shield which is adaptable to withstand various temperatures.

These and other objects and advantages of the invention will become apparent upon consideration of the drawings and detailed description of the preferred embodiments.

### BRIEF DESCRIPTION OF THE DRAWINGS

FIG. 1 is a partial cut-away perspective view of a heat shield according to the invention; and

FIG. 2 is a perspective view of an alternate embodiment of a heat shield according to the invention.

### DETAILED DESCRIPTION OF THE PREFERRED EMBODIMENTS

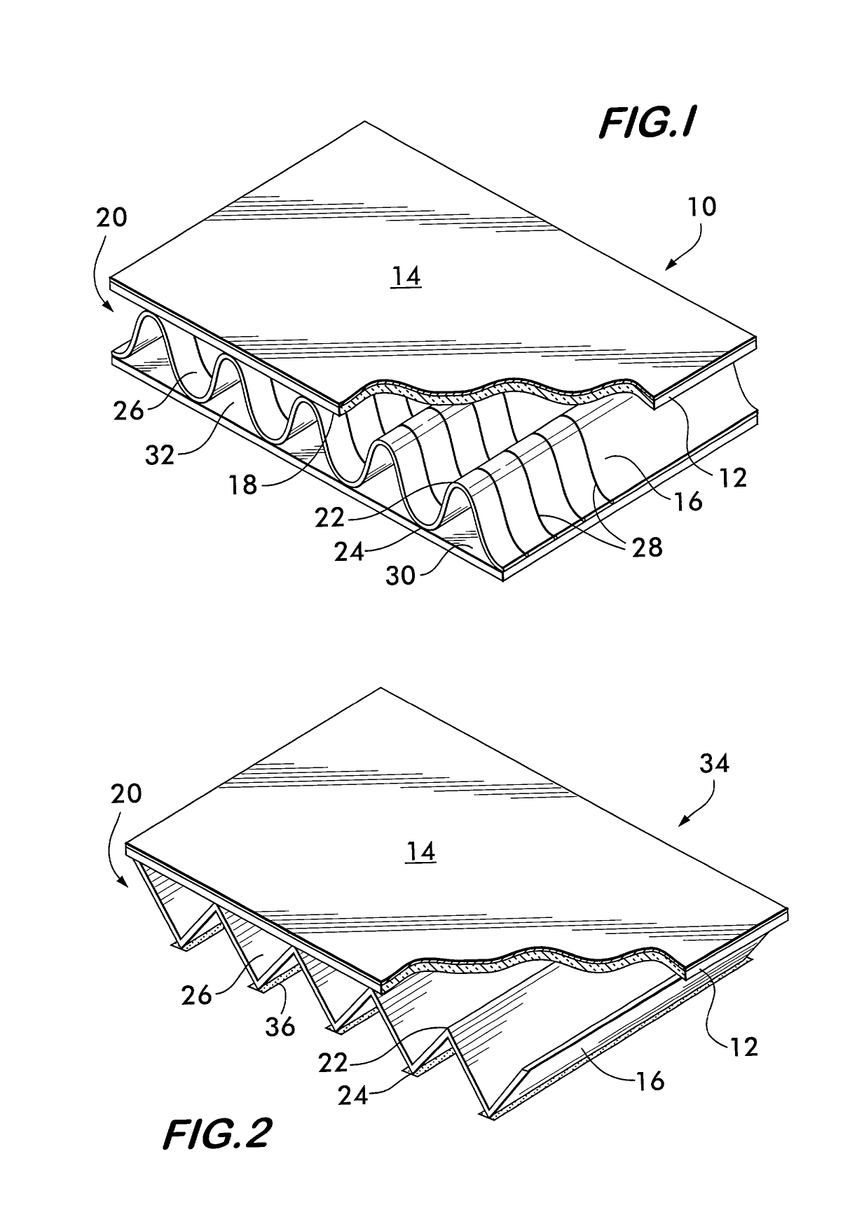

FIG. 1 shows a flexible radiative heat shield 10 according to the invention. Heat shield 10 comprises a flexible substrate 12 having an outwardly facing reflective surface 14. Substrate 12 is preferably a durable insulating material such as Mylar and the reflective surface is formed by vapor deposition of a thin film of metal, such as aluminum, onto the Mylar. The Mylar substrate 12 provides a robust layer which can withstand rough handling and physical abuse, is resistant to moisture, heat, cold and chemical attack and is well suited for use in harsh environments such as the engine compartment or the underside chassis of an automobile. Being an insulator the Mylar also offers further resistance to conductive heat transfer, while the thin reflecting metal film substantially reduces radiative heat transfer across the substrate. The reflective substrate may also be comprised of a reflective metal foil such as aluminum or stainless steel for enhanced corrosion resistance.

An insulating layer 16 is attached to substrate 12 on a side 18 opposite to the reflective surface 14. Insulating layer 16 is comprised of an insulating material chosen, as described below, in relation to the maximum temperatures to which the heat shield is expected to be exposed. The insulating layer 16 has corrugations 20 comprising a plurality of crests 22 positioned in alternating fashion with a plurality of troughs 24, the crests being attached to the substrate 12 preferably by adhesive bonding. Troughs 24 define a plurality of air pockets 26 between the insulating layer 16 and the substrate 12. The air pockets substantially enhance the heat shield's ability to inhibit conductive heat transfer. Furthermore, by attaching the insulating layer 16 to the substrate 12 only at the crests 22 the contact area between the substrate and insulating layer is reduced, further inhibiting the potential for conductive heat transfer across the heat shield.

Insulating layer 16 may be formed of various materials as required for a particular temperature environment. For example, in relatively high temperature applications (to about 300° C.) glass fiber paper or ceramic paper comprise layer 26. For medium temperature applications to about 150° C., polyester paper is be adequate. For lower temperature range applications to about 100° C., the insulating layer may comprise cotton. Depending upon the material comprising the insulating layer 16, it may be necessary to provide a plurality of biasable filamentary members 28 throughout the insulating layer. Biasable filamentary members 28 are preferably embedded within the insulating layer, arranged transversely to the corrugations 20 and resiliently biasable into a waveform shape matched to the corrugations to resiliently maintain the shape of the crests and troughs, thereby preventing collapse of the air pockets. The biasable filamentary members 28 preferably comprise thermoplastic monofilaments which are readily heat settable into the desired shape. Thermoplastic monofilaments are furthermore inherently insulating and thus will not compromise the insulating characteristics of the insulating layer 16. Other materials, such as yieldably biasable metal wires may also be used.

If increased strength and stiffness of the heat shield is desired, a reinforcing layer 30 is attached to the troughs 24. The reinforcing layer is preferably a scrim made of woven or non-woven insulating material, such as paper or glass fibers. The scrim is adhesively bonded to the troughs. The reinforcing layer 30 together with the crests 22 define further air pockets 26 in the heat shield and provides yet another insulating layer inhibiting conductive heat transfer across the heat shield 10. The reinforcing layer 30 provides an interface for mounting the heat shield 10 to the component to be protected. The mounting is preferably by adhesive bonding, but fasteners may also be used.

FIG. 2 shows an alternate embodiment of a heat shield 34 according to the invention. Similarly to the first embodiment described above, heat shield 34 comprises a substrate layer 12, preferably of insulating material such as Mylar and having a reflecting surface 14 comprising a film of vapor deposited aluminum. An insulating layer 16 is again attached opposite to the reflecting surface 14, the insulating layer again having corrugations 20 formed of crests 22 and troughs 24, the troughs defining air pockets 26. Note that the shape of the crests and troughs is different from those illustrated in the embodiment of FIG. 1, being a saw-toothed wave rather than a sinusoid. No reinforcing layer is used in the embodiment 34, the troughs 24 being directly attachable to the component to be protected by means such as adhesive layers 36.

Heat shields 10 and 34 according to the invention may be manufactured using an in-line corrugating machine to form the insulating layer 16, the corrugated layer being sent thereafter to a laminator, which, under heat and pressure, attaches the substrate 12 and the reinforcing layer 30 if used. The size of air pockets 26 and 32 are controlled by the in-line corrugator, which has interchangeable corrugating wheels providing for different depths of the corrugations.

Through judicious choice of materials, shapes and arrangement of the various layers comprising the heat shield according to the invention, a robust, lightweight, flexible, inexpensive and effective means for protecting components from radiant heat is available which can be readily adapted across a wide spectrum of applications.

What is claimed is:

1. A flexible heat shield reducing radiative and conductive heat transfer, said heat shield comprising:
a flexible substrate having an outwardly facing reflective surface; and
a flexible insulating layer attached to said substrate, said insulating layer being oppositely disposed to said reflective surface, said insulating layer having corrugations comprising a plurality of crests and troughs, said crests engaging said substrate, said corrugations defining a plurality of air pockets between said insulating layer and said substrate.

2. A heat shield according to claim 1, further comprising a reinforcing layer attached to said insulating layer, said reinforcing layer engaging said troughs, said corrugations further defining a second plurality of air pockets between said insulating layer and said reinforcing layer.

3. A heat shield according to claim 1, further comprising an adhesive layer engaging said troughs for attaching said heat shield to a surface.

4. A heat shield according to claim 1, wherein said substrate comprises a layer of metal foil.

5. A heat shield according to claim 1, wherein said substrate comprises a non-conducting layer having an outwardly facing metalized reflective surface.

6. A heat shield according to claim 5, wherein said non-conducting layer comprises Mylar sheet and said metalized surface comprises vacuum deposited aluminum.

7. A heat shield according to claim 1, where said insulating layer comprises glass fiber paper.

8. A heat shield according to claim 1, wherein said insulating layer comprises ceramic paper.

9. A heat shield according to claim 1, wherein said insulating layer comprises polyester.

10. A heat shield according to claim 1, wherein said insulating layer comprises cotton.

11. A heat shield according to claim 1, further comprising a plurality of resilient, elongated filamentary members distributed throughout said insulating layer and oriented transversely to said corrugations, said filamentary members being resiliently biasable into a waveform shape matched to said corrugations and resiliently maintaining the shape of said crests and troughs.

12. A heat shield according to claim 11, wherein said filamentary members comprise thermoplastic monofilaments.
